(19) United States
(12) Patent Application Publication
(10) Pub. No.: US 2002/0036111 A1
(43) Pub. Date: Mar. 28, 2002

(54) Electric power steering device

(76) Inventor: Hideaki Noguchi, Ashikaga (JP)

Correspondence Address: MARSHALL & MELHORN, LLC, PHILLIP S. OBERLIN, 8TH FLOOR, FOUR SEAGATE, TOLEDO, OH, 43604, US

(21) Appl. No.: 09/950,399

(22) Filed: Sep. 10, 2001

(30) Foreign Application Priority Data
Sep. 25, 2000 (JP) 2000-290206

(51) Int. Cl. B62D 5/04

(52) U.S. Cl. 180/444

(57) ABSTRACT

An electric power steering device comprises: a generally tubular casing fixedly attached to a vehicle body; an electric motor provided in the casing and having a hollow rotor shaft; a steering gear portion provided to a portion of the casing that is displaced from an axially middle portion of the casing; a steering force transmitting rod coaxially received in the hollow rotor shaft so as to be moveable in an axial direction and connected to a steering shaft via the steering gear portion; and a drive force converter provided between the electric motor and the steering force transmitting rod to convert a rotational movement of the electric motor into an axial movement of the steering force transmitting rod, wherein the electric motor is displaced from the axially middle portion of the casing in a direction away from the steering gear portion and the drive force converter is located on a steering gear portion side of the electric motor. In this way, since the electric motor is displaced from the axially middle portion of the casing of the steering device, it is possible that the power steering device has no protruding portion at or near its axially middle portion, which is usually aligned with a vehicle widthwise center when the steering device is attached to the vehicle. This can prevent interference between the steering device and such component as a propeller shaft or muffler usually provided underside of the vehicle at or near the vehicle center line.

### TECHNICAL FIELD

The present invention relates to an electric power steering device.

### BACKGROUND OF THE INVENTION

In a field of a steering device for an automobile, an electric power steering device that utilizes an electric motor to reduce a steering force required for an operator to steer the automobile is conventionally known. An example of such an electric power steering device is shown in FIG. 3.

The electric power steering device shown in FIG. 3 comprises a cylindrical casing 1 to be attached to a vehicle body (not shown) so that the casing 1 extends in a widthwise direction of the vehicle body. In the casing 1, a rack shaft 2 serving as a steering force transmitting rod is received so as to be moveable in an axial direction. The steering force from a steering shaft (not shown) is transmitted to the rack shaft 2 via a steering gear portion 3 of a rack and pinion type, which is located at a position displaced from an axially middle portion of the casing 1.

An electric motor 4 for generating a steering assist force and thereby reducing the steering force is constituted in the axially middle portion of the casing 1. In order to convert a rotational movement of the electric motor 4 into an axial movement of the rack shaft 2, the electric motor 4 has a hollow rotor shaft 4a into which the rack shaft 2 is received coaxially, and a ball screw mechanism 6 is provided between the rack shaft 2 and the hollow rotor shaft 4a. Thus the ball screw mechanism 6 serves as a drive force converter. Specifically, the ball screw mechanism 6 is constituted by a threaded section formed on the inner circumferential surface of the hollow rotor shaft 4a; a spiral ball screw threaded section 2a provided to the rack shaft 2; and a plurality of balls disposed between the two threaded sections.

The casing 1 can be attached to the vehicle body via a vehicle body attachment bracket portion 1a that is formed unitarily at a position close to the steering gear portion 3 of the casing 1 and a separate bracket 5 for supporting an axial end portion of the casing 1 that is positioned away from the vehicle body attachment bracket portion 1a so as to allow an axial relative movement of the casing 1. The vehicle body attachment bracket portion 1a integral to the casing 1 mainly bears an axial force (or thrust load) while the bracket 5 which is a separate member from the casing 1 mainly supports a radial force (or radial load) of the casing 1.

When the electric power steering device described as above is used in a four-wheel-drive vehicle, however, since underside component parts 8 such as a muffler or propeller shaft for the four-wheel-drive are usually disposed near a lateral center line C of the vehicle body as shown by phantom lines in FIG. 3, a problem may arise that such underside component parts 8 interfere with the electric power steering device extending in the lateral direction of the vehicle body.

In the electric power steering device in FIG. 3, the central portion of a ball screw threaded section 2a formed on the rack shaft 2 is usually required to be aligned with the central portion of the threaded section formed on the inner circumferential surface of the hollow rotor shaft 4a in the condition that the vehicle is traveling straight (or neutral condition). To prevent the interference with the underside component parts 8, it is necessary in the electric power steering device of FIG. 3 to displace the electric motor 4 to the left in the drawing. However, considering a range of lateral movements of the rack shaft 2, the ball screw mechanism 6 cannot be substantially displaced to the left in the drawing because it is required to prevent the ball screw threaded section 2a from interfering with a thrust bearing 10 formed in the casing 1 to support the left end portion of the rack shaft 2. This creates a problem that the freedom of arrangement of the underside component parts 8 as well as of configuration of electric power steering device (electric motor 4) is quite limited, rendering it difficult to increase the core laminar of the electric motor 4 to achieve higher output power, for example.

### BRIEF SUMMARY OF THE INVENTION

In view of such problems of the prior art, a primary object of the present invention is to provide an electric power steering device that can avoid interfere with other component parts disposed underside of a vehicle body.

A second object of the present invention is to provide an electric power steering device that can allow a wider flexibility in the design of the electric power steering device.

A third object of the present invention is to provide such an electric power steering device with minimum modification from the conventional power steering device.

According to the present invention, such objects can be accomplished by providing an electric power steering device, comprising: a generally tubular casing fixedly attached to a vehicle body; an electric motor provided in the casing and having a hollow rotor shaft; a steering gear portion provided to a portion of the casing that is displaced from an axially middle portion of the casing; a steering force transmitting rod coaxially received in the hollow rotor shaft so as to be moveable in an axial direction and connected to a steering shaft via the steering gear portion; and a drive force converter provided between the electric motor and the steering force transmitting rod to convert a rotational movement of the electric motor into an axial movement of the steering force transmitting rod, wherein the electric motor is displaced from the axially middle portion of the casing in a direction away from the steering gear portion and the drive force converter is located on a steering gear portion side of the electric motor.

In this way, since the electric motor is displaced from the axially middle portion of the casing of the steering device, it is possible that the power steering device has no protruding portion at or near its axially middle portion, which is usually aligned with a vehicle widthwise center when the steering device is attached to the vehicle. Therefore, even when underside component parts such as a propeller shaft or muffler extend in a longitudinal direction of the vehicle body near the center line of the same, it is possible to avoid the interference between such component parts and the electric power steering device. This also increases the freedom of configuration of the electric power steering device because increase in the core laminar of the electric motor of the electric power steering device, for example, would not interfere with the underside component parts.

Further, since the drive force converter is disposed on a steering gear portion side of the electric motor, i.e., on a vehicle center side with respect to the electric motor, it is possible to ensure a sufficient space for providing the drive force converter. Particularly, in the case that the drive force converter comprises a ball screw mechanism, it is allowed that the steering force transmitting rod can provide a sufficient portion for forming a ball screw threaded section thereon.

Preferably a bracket for attaching the power steering device to a vehicle body is unitarily provided to the casing at a position between the steering gear portion and the drive force converter. In this way, an external force caused by an impact on a wheel, for example, is transmitted to the bracket of the casing via the steering force transmitting rod and drive force converter, and then from the bracket to the vehicle body. Thus, the force transmitted from the wheel to the vehicle body via the bracket substantially does not pass the portion of the casing where the electric motor is constituted, and thus the strength required to the portion of the casing can be reduced, thereby allowing this portion to have a smaller thickness and thus achieving a reduced radial size and/or weight of the steering device.

Other and further objects, features and advantages of the invention will appear more fully from the following description.

### BRIEF DESCRIPTION OF THE DRAWINGS

Now the present invention is described in the following with reference to the appended drawings, in which:

FIG. 1 shows an overall longitudinal cross-sectional view, with part broken, of an embodiment of an electric power steering device according to the present invention;

FIG. 2 is an enlarged view of a part of the electric power steering device shown in FIG. 1; and

FIG. 3 shows an overall longitudinal cross-sectional view, with part broken, of a conventional electric power steering device.

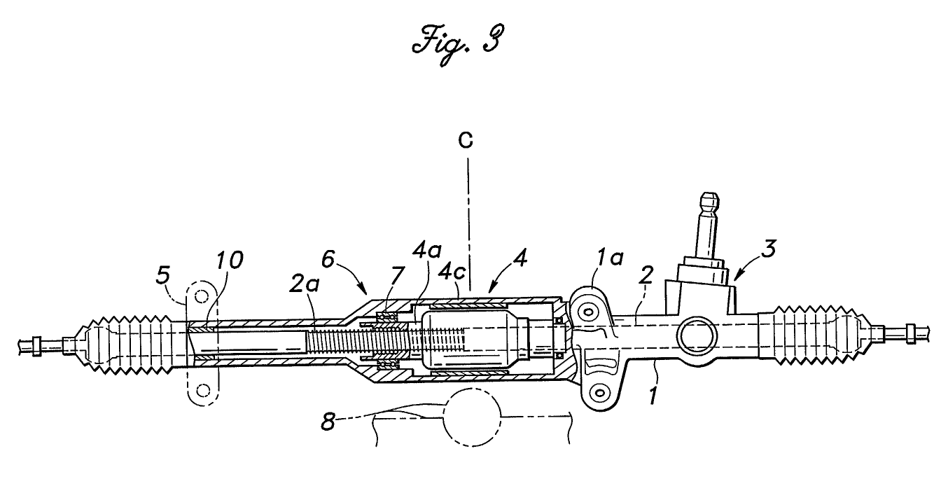

### DETAILED DESCRIPTION OF THE PREFERRED EMBODIMENTS

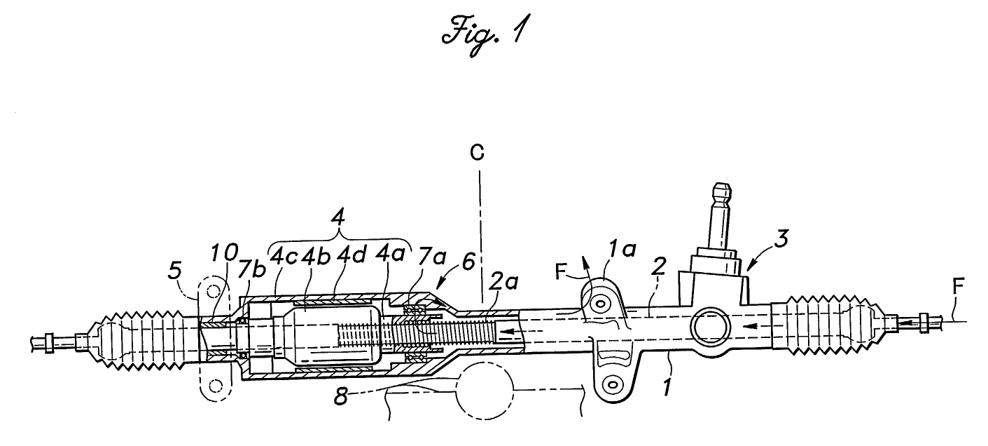

FIG. 1 shows an overall view of an electric power steering device according to the present invention, in which component parts similar to those of the conventional embodiment are denoted with the same reference numerals and detailed explanation thereof is omitted. In this embodiment also, a rack shaft 2 serving as a steering force transmitting rod is received in a hollow casing 1 coaxially and reciprocatingly moveable in an axial direction of the steering device, and either ends of the rack shaft 2 are connected via tie rods to respective front wheels (not shown) serving as steerable wheels. Further, the rack shaft 2 is connected to a steering shaft (not shown) via a steering gear portion 3 of a rack and pinion type.

As shown in FIG. 1, an electric motor 4 of this electric power steering device is displaced in a widthwise direction of the vehicle from a vehicle center line C or in other word, displaced from an axially middle portion of the steering device (or casing 1) in an axial direction of the same. In order to securely attach the casing 1 to a vehicle body (not shown), a vehicle body attachment bracket portion 1a is formed unitarily in the casing 1 near the steering gear portion 3 which is displaced from the axially middle portion of the casing 1. An axial end portion of the casing 1 opposite to the steering gear portion 3 is supported to the vehicle body via a separate bracket 5.

In the electric motor 4, a hollow rotor shaft 4a surrounding the rack shaft 2 is unitarily formed with an armature 4b, and a magnet 4d is disposed on an inner circumferential surface of a housing portion 4c formed as a larger diameter portion of the casing 1. Either ends of the hollow rotor shaft 4a are rotateably supported by bearings 7a, 7b and a ball screw mechanism 6 serving as a drive force converter for converting a rotational movement of the electric motor 4 into an axial movement of the rack shaft 2 is provided at a position corresponding to the bearing 7a that is closer to the steering gear portion 3. The ball screw mechanism 6 comprises: a threaded section formed on the inner circumferential surface of the hollow rotor shaft 4a; a spiral ball screw threaded section 2a provided to the rack shaft 2; and a plurality of balls disposed between the two threaded sections. The spiral threaded section 2a is arranged to determine the same prescribed left and right (with respect to the vehicle) linear moveable ranges with respect to a portion corresponding to the threaded section of the hollow rotor shaft 4a in the neutral condition.

As described above, in this embodiment, the electric motor 4 is displaced laterally from the vehicle center line C in the state that the electric power steering device is attached to the vehicle body. Thus, the electric power steering device has no protruding portion at and near the vehicle center line C. In this way, the electric power steering device can be attached to the vehicle body without interfering with component parts 8 such as a muffler or propeller shaft shown by phantom lines in FIG. 1 which are usually disposed underside of the vehicle body at or near the vehicle center line C. This can allow a wider flexibility in the design of the electric power steering device. For example, it is possible to increase the core laminar of the electric motor 4 to achieve higher output power without interfering with the underside component parts 8.

Further, in the electric power steering device shown in FIG. 1, the ball screw mechanism 6 is provided on a side of the steering gear portion 3 (or the vehicle body center line C) with respect to the electric motor 4. This can prevent an end portion of the rack shaft 2 from interfering with the bearing 7b when the rack shaft 2 is fully moved to the left in the drawing and thus achieve a sufficiently large range of axial (or left-right in the drawing) movement of the rack shaft 2 while allowing that the central portions of the threaded section of the hollow rotor shaft 4a and the threaded section 2a of the rack shaft 2 to be aligned in the neutral condition.

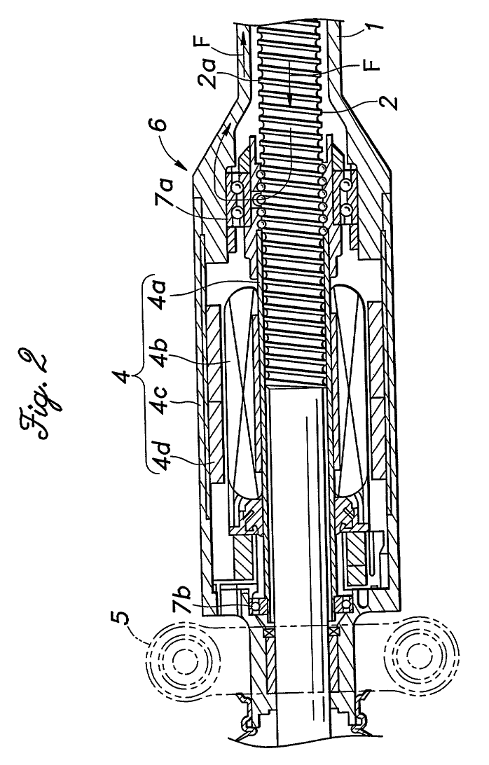

An external force caused by an impact on a wheel, for example, is transmitted to the bracket portion 1a of the casing 1 via the rack shaft 2 and the ball screw mechanism 6, and then from the bracket portion 1a to the vehicle body. In this electric power steering device, unlike the conventional one, the ball screw mechanism 6 is disposed between the bracket portion 1a and the electric motor 4, and thus, the force transmitted from the wheel to the vehicle body via the bracket portion 1a substantially does not pass the housing portion 4c of the casing 1 where the electric motor 4 is constituted. This is clearly shown by arrows F in FIG. 1 as well as in FIG. 2.

Therefore, the strength required to the portion of the casing 1 (or more specifically housing 4c) at which the magnet 4d is provided can be reduced, thereby allowing this portion to have a smaller thickness and thus achieving a reduced radial size and/or weight of the steering device. It should be noted that even with the reduced radial size of the portion of the housing 4c, the portion where the bearing 7a is formed can be provided with a sufficiently large thickness because this portion has a smaller inner diameter than the portion where the magnet 4d is disposed as shown in FIG. 1.

Thus, according to the present invention, because the electric motor 4 can be displaced laterally from the vehicle center line, and thus the electric power steering device has no protruding portion at and near the vehicle center line. Therefore, the electric power steering device can be attached to the vehicle body without interfering with component parts such as a muffler or propeller shaft which are usually disposed underside of the vehicle body at or near the vehicle center line. This can allow a wider flexibility in the design of the electric power steering device. For example, it is possible to increase the core laminar of the electric motor to achieve higher output power without interfering with the underside component parts.

Although the present invention has been described in terms of a preferred embodiment thereof, it is obvious to a person skilled in the art that various alterations and modifications are possible without departing from the scope of the present invention which is set forth in the appended claims.

1. An electric power steering device, comprising:
a generally tubular casing fixedly attached to a vehicle body;
an electric motor provided in the casing and having a hollow rotor shaft;
a steering gear portion provided to a portion of the casing that is displaced from an axially middle portion of the casing;
a steering force transmitting rod coaxially received in the hollow rotor shaft so as to be moveable in an axial direction and connected to a steering shaft via the steering gear portion; and
a drive force converter provided between the electric motor and the steering force transmitting rod to convert a rotational movement of the electric motor into an axial movement of the steering force transmitting rod,
wherein the electric motor is displaced from the axially middle portion of the casing in a direction away from the steering gear portion and the drive force converter is located on a steering gear portion side of the electric motor.

2. An electric power steering device according to claim 1, wherein the drive force converter comprises a ball screw mechanism.

3. An electric power steering device according to claim 1, wherein a bracket for attaching the power steering device to a vehicle body is unitarily provided to the casing at a position between the steering gear portion and the drive force converter.

4. An electric power steering device according to claim 1, wherein the electric motor is displaced from a lateral center of a vehicle in the state that the electric steering device is attached to the vehicle body.
